(19) United States
(12) Patent Application Publication
(10) Pub. No.: US 2017/0228726 A1
(43) Pub. Date: Aug. 10, 2017

(54) SYSTEMS AND METHODS FOR SECURE TRANSACTIONS

(71) Applicant: AMERICAN EXPRESS TRAVEL RELATED SERVICES COMPANY, INC., New York, NY (US)

(72) Inventors: Billy Bohanan, Phoenix, AZ (US); Brady Cullimore, Mesa, AZ (US); Justin Flaishans, Phoenix, AZ (US); Dinesh Gudibandi, Phoenix, AZ (US); Sean Maize, Phoenix, AZ (US); Robert Mckay, Mesa, AZ (US); ShahanasSalam NaduvilePurayil, Scottsdale, AZ (US); Rakesh Pattanayak, Phoenix, AZ (US); Dan Sorensen, Glendale, AZ (US); Andrew Sosnicki, Scottsdale, AZ (US)

(73) Assignee: AMERICAN EXPRESS TRAVEL RELATED SERVICES COMPANY, INC., New York, NY (US)

(21) Appl. No.: 15/016,000

(22) Filed: Feb. 4, 2016

(51) Int. Cl. G06Q 20/38; G06Q 20/40; G06Q 20/20

(52) U.S. Cl. CPC G06Q 20/3829; G06Q 20/206; G06Q 20/4014; G06Q 20/4016

(57) ABSTRACT

A system may transmit a time-based token to the merchant device. The system may receive a second merchant session key, a customer session key, a customer ID, a customer device certificate, and a second transaction amount from a customer device. The system may further match the first merchant session key to the second merchant session key, and transmit the time-based token to the customer device in response to the first merchant session key matching the second merchant session key.

### FIELD

The present disclosure relates to secure transactions for purchasing goods and/or services using a short-range communication channel.

### BACKGROUND

Purchase transactions occur every day and are often executed at a point of sale. A customer may swipe a card at a merchant location and the corresponding transaction account may be charged for the purchase. The information used in the transaction may be processed by the point of sale and sent to a creditor for fraud checks and credit line checks. The creditor may approve or decline the transaction. The merchant may accumulate multiple transactions throughout the course of the day and upload the transactions in a batch process at the end of the day. The transaction accounts may be debited with the transaction amounts uploaded at the end of the day.

The current nature of the batch processing opens transactions to failure and attack points. For example, payment devices (cards, mobile devices, etc.) may be subject to skimming. Skimming is a process by which payment data is stolen from legitimate payment devices. Security may also be breached on the merchant side if the merchant point-of-sale terminal or payment system is compromised by hackers. Payment data can also be picked up by nearby scanners during a contactless interaction between a payment device and a point-of-sale terminal. Furthermore, payment devices and point-of-sale terminals used for card-present transactions utilize chip technology which does not secure the card-not-present channel used for online purchases.

### SUMMARY

A system, method, and computer readable medium (collectively, the “system”) is disclosed for securely completing transactions using a short-range communication channel. The system may receive a merchant identifier, a first merchant session key, a merchant device certificate, and a first transaction amount from a merchant device. The system may also transmit a time-based token to the merchant device. The system may receive a second merchant session key, a customer session key, a customer ID, a customer device certificate, and a second transaction amount from a customer device. The system may further match the first merchant session key to the second merchant session key, and transmit the time-based token to the customer device in response to the first merchant session key matching the second merchant session key.

In various embodiments, the system may match the first transaction amount to the second transaction amount. The system may also transmit the time-based token to the customer device in response to the first transaction amount matching the second transaction amount. The second merchant session key may be received by the customer device from the merchant device over a short-range communication channel, such as a Bluetooth Low Energy (BLE) link. The system may provision the customer device with the customer device certificate and the merchant device with the merchant device certificate. The system may also receive a first validation credential from the customer device and a second validation credential from the merchant device, and compare the first validation credential to the second validation credential to detect an alteration.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

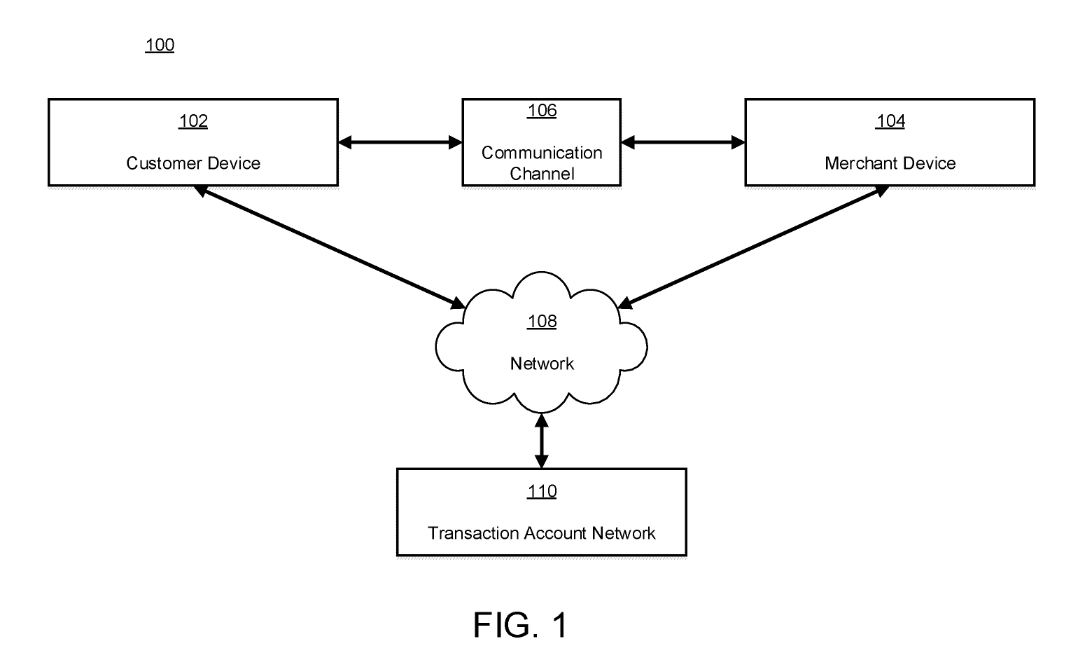

FIG. 1 illustrates an exemplary system for completing secure transactions, in accordance with various embodiments;

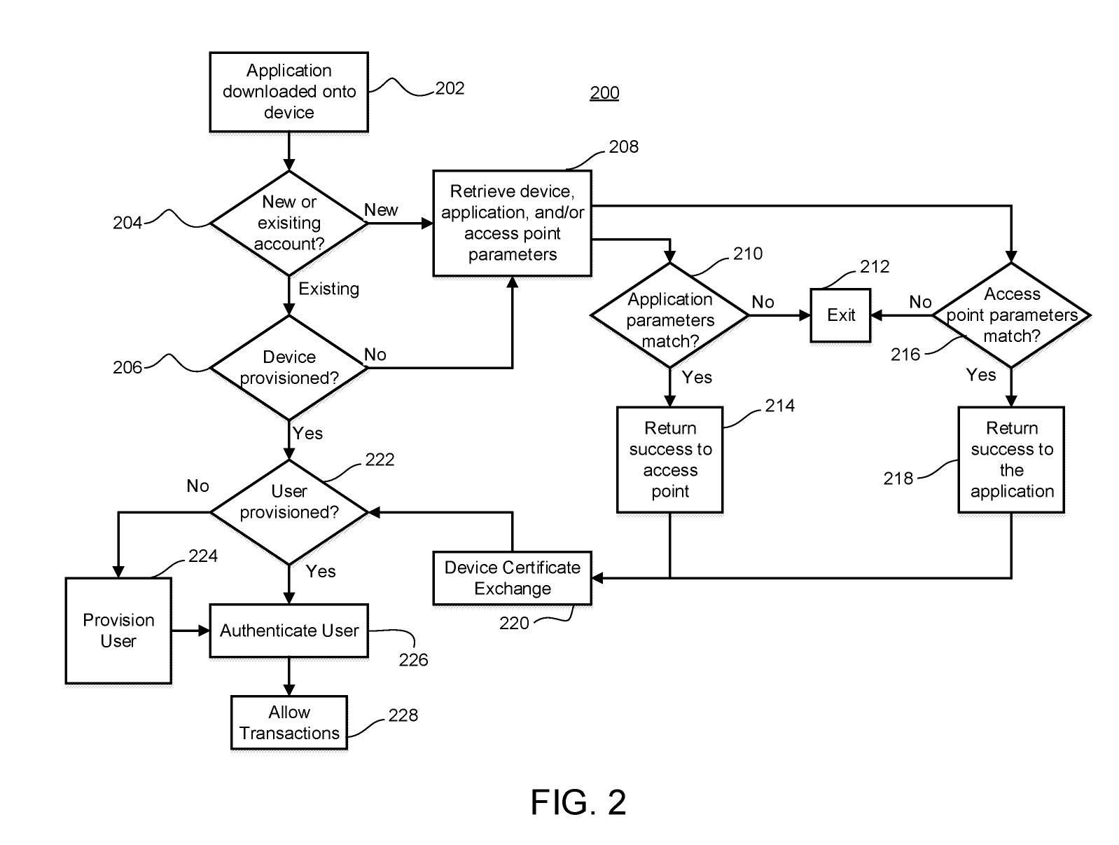

FIG. 2 illustrates an exemplary process for provisioning devices to complete secure transactions using a short range transmission protocol, in accordance with various embodiments;

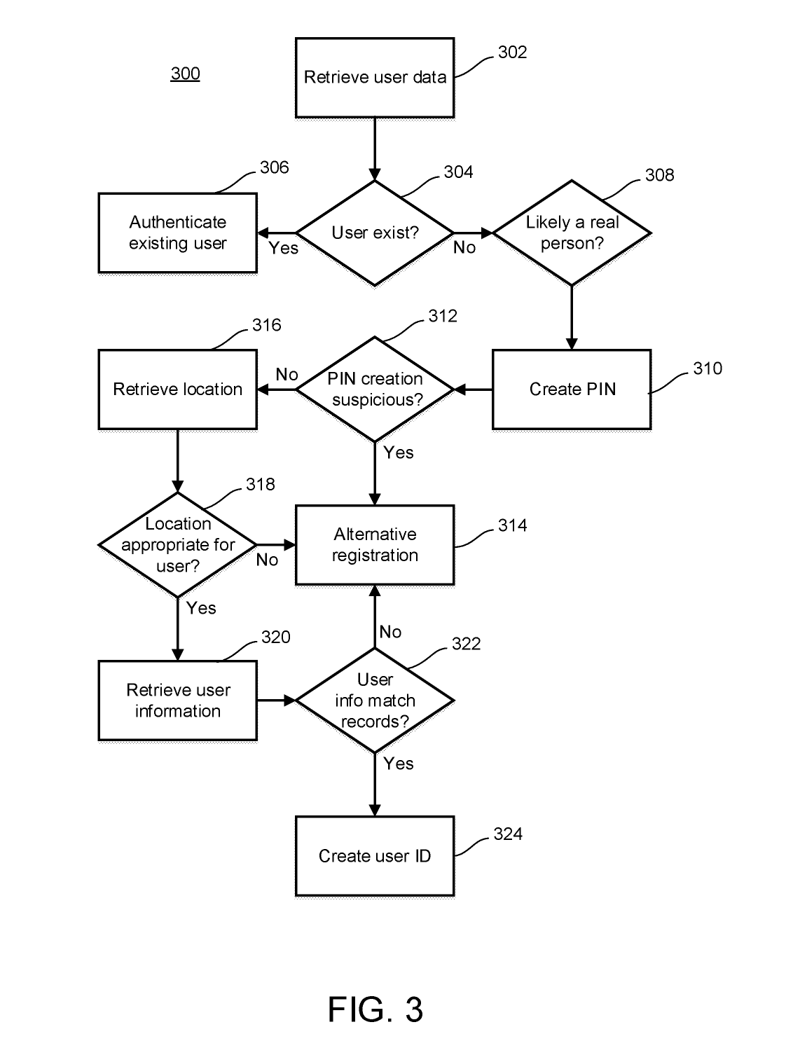

FIG. 3 illustrates an exemplary process for provisioning users to complete transactions using a short range transmission protocol, in accordance with various embodiments; and

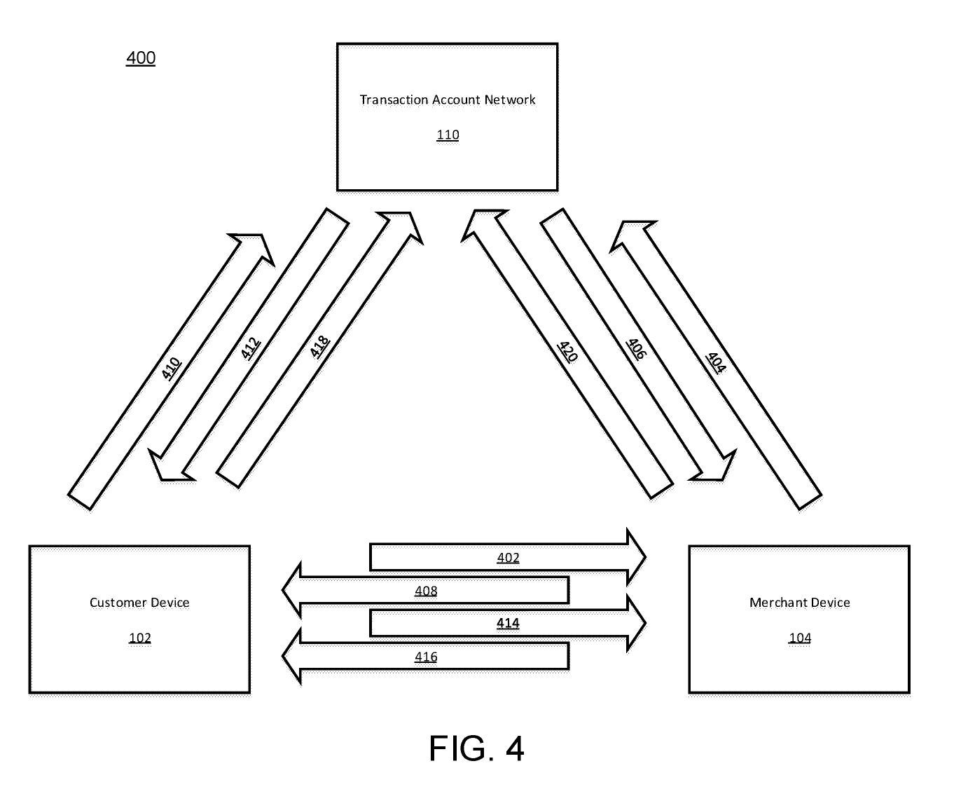

FIG. 4 illustrates an exemplary process for completing a transaction between a customer and merchant using a short range transmission protocol, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The transaction systems fully or partially prevent fraudulent transactions using a short-range transmission technology. A certificate exchange between merchant and customer may be verified by a transaction account network to ensure the identities of the customer and merchant. The devices used in the transaction may also be registered and approved. The devices may be capable of implementing always-on technologies, such as a Bluetooth® low energy (BLE), to facilitate communication between the customer and merchant.

With reference to FIG. 1, a system 100 for completing secure transactions is shown, in accordance with various embodiments. System 100 includes customer device 102 and merchant device 104 in communication over communication channel 106. Consumer device 102 and merchant device 104 may also be in communication with network 108 and other devices connected to network 108.

System 100 may complete secure transactions by securely provisioning (i.e., registering) users and/or devices such as customer device 102 and/or merchant device 104, as described in greater detail below. The known users and devices may exchange information over communication channel 106 (e.g., over a BLE link between the customer device 102 and merchant device 104). The exchanged information may be used to verify the identity of each transacting party by transmission to transaction account network 110 (e.g., a financial institution) over network 108 (e.g., the Internet). The components of system 100 may include capabilities to facilitate communication and validation. Users of customer device 102 and merchant device 104 may be associated with a transaction account to complete a transaction between the two entities.

A merchant device 104 and/or a customer device 102 may be any device (e.g., personal computing device/mobile communication device) which communicates via any network 108 and/or via a short-range wireless protocol such as BLE. A web client or dedicated application may be associated with and/or used by a customer device, a merchant device, or both. In this regard, a web client may comprise a variety of browsing software or browser applications (e.g., Microsoft Internet Explorer, Mozilla Firefox, Google Chrome, Apple Safari, a dedicated micro-application, or any other suitable software packages available for communicating over a network 108 and/or communication channel 106). Such browser applications may comprise network 108 capable software installed within a computing unit or a system to conduct online transactions and/or communications. These computing units or systems may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Droid®, etc.) tablets such as iPads, wearable computing devices such as smart watches or smart glasses, or any suitable device capable of receiving data over network 108 and/or over a communication channel 106.

As those skilled in the art will appreciate, a customer or merchant device may include an operating system (e.g., Windows NT, 95/98/2000/CE/Mobile, OS2, UNIX, Linux, Solaris, iOS, etc.) as well as various conventional support software and drivers typically associated with computers. A customer or merchant device may implement security protocols such as Secure Sockets Layer (SSL) and Transport Layer Security (TLS) for communication over network 108. A customer or merchant device may also implement one or more application layer protocols, including, for example, http, https, ftp, and sftp. Transactions originating at a customer or merchant device may pass through a firewall (not shown; see below) in order to prevent unauthorized access from users of network 108.

As used herein, a “micro location” of a customer may comprise a location of a customer in relation to one or more transmission devices. For example, a merchant transmission device may be a BLE enabled device (e.g., a smartphone, tablet, or other point-of-sale device) communicating using a low power or low-energy and short-range communication standard. The BLE standard may enable working ranges for communication with adjustable controls. For example, a BLE-capable merchant device 104 may be configured to interact with other BLE customer devices 102 within a predetermined range within the BLE operating distance. For example, the predetermined range may be 2 foot, 5 foot, 20 foot, or 50 foot range.

In various embodiments, the customer device 102 and merchant device 104 may be capable of communication with a device within a micro location of the device (e.g., to within approximately 30 meters or less). As described above, a transmission device (e.g., customer device 102 and/or merchant device 104) may comprise any device capable of transmitting and/or receiving a signal wirelessly using a low power or low energy connection. In that regard, communication between customer device 102 and merchant device 104 may be secure at least in part due to the limited number of eaves droppers present in the predetermined communication range.

Network 108 may comprise any electronic communications system or method that incorporates software and/or hardware components. Communication may be accomplished through any suitable communication channels, such as, for example, a telephone network, an extranet, an intranet, Internet, point of interaction device (point of sale device, personal digital assistant, smart phone, cellular phone (e.g., iPhone®, Android®), kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although a network 108 may be described herein as being implemented with TCP/IP communications protocols, the network 108 may also be implemented using IPX, Appletalk, IP-6, NetBIOS, OSI, any tunneling protocol (e.g. IPsec, SSH), or any number of existing or future protocols.

If the network 108 is in the nature of a public network, such as the Internet, it may be advantageous to presume the network 108 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components described herein may be independently, separately or collectively coupled to the network 108 via one or more data links including, for example, a connection to an Internet Service Provider (ISP) over a local loop as is typically used in connection with standard modem communication, cable modem, Dish networks, ISDN, or Digital Subscriber Line (DSL). It is noted that the network 108 may be implemented variously. The systems and methods disclosed herein contemplate the use, sale and/or distribution of any goods, services or information over any network having functionality similar to that described above with reference to network 108.

With reference to FIG. 2, a process 200 for provisioning customer device 102 and/or merchant device 104 to complete transactions with transaction account network 110 is shown, in accordance with various embodiments. An application may be loaded onto customer device 102 and/or merchant device 104 to facilitate communication over network 108 (Block 202). The application may be a dedicated transaction application configured to complete secure transactions by communicating with transaction account network 110 over network 108. Transaction account network 110 may determine whether a new account and/or existing account is going to be used on the application (Block 204). If an existing account is used, transaction account network 110 may determine whether the customer device 102 and/or merchant device 104 that downloaded the application is already provisioned (Block 206). If the device is not provisioned and/or a new account will be used, transaction account network 110 may retrieve application parameters and access point parameters (Block 208). Application parameters may include device specific information such as application installation size, application signature, application source IP address, and/or the application itself, as well as device specific information such as hardware configuration, device ID, MAC address, device cellular account information, and/or other device information to validate the application installation on the device. Access point parameters may include an IP address, a geographic location, a transaction history, and/or other access point information. Device parameters may be used to determine whether the device is trustworthy. For example, geolocation may be used to determine whether the location of the device makes sense for the associated account based on locations appearing in the account transaction history.

Transaction account network 110 may determine whether the application parameters match expected application parameters (Block 210). In that regard, transaction account network 110 may verify that the application is not compromised. If the application parameters do not match, transaction account network 110 may exit (Block 212). If the application parameters match the expected parameters, transaction account network 110 may return success to the access point (Block 214).

Transaction account network 110 may also determine whether the access point parameters match the expected access point parameters (Block 216). If the access point parameters do not match, transaction account network 110 may exit (Block 212). If the access point parameters do match expected values, the transaction account network 110 may return success to the application (Block 218). Transaction account network 110 may also retry the above validation process prior to exiting. Exiting may be accompanied by a message describing the failure and/or providing a solution. In response to successful validation, the transaction account network 110 may provide a device certificate to customer device 102 and/or merchant device 104 (Block 220). The certificate may be unique to the device and may be used for secure transactions as described in further detail below.

In various embodiments, system 100 may register users (e.g., customers and merchants using customer device 102 and merchant device 104, respectively) as well as devices to further enhance security. In that regard, transaction account network 110 may check whether the user is provisioned (Block 222). If the user is provisioned, transaction account network 110 may authenticate the user (Block 226). User authentication may include authentication on the user device such as requiring a user to enter a device PIN (personal identification number) and/or pass biometric checks as measured by the device, such as fingerprints and facial images. The device and user may be ready to transact (Block 228) in response to completion of the provisioning process. If the user has not been provisioned, transaction account network 110 may provision the user prior to allowing transactions (Block 224).

With reference to FIG. 3, an exemplary process 300 for provisioning users of customer devices 102 and/or merchant devices 104 is shown, in accordance with various embodiments. Transaction account network 110 may retrieve user information (Block 302). The user information may be provided by the user and/or retrieved from a user database for existing users. User information may also be retrieved from social media sites such as Facebook®, LinkedIn®, Twitter®, Instagram®, or other outlets for user information. Information retrieved from social media sites may be compared to user information provided by the user to conduct facial recognition and/or voice recognition and authenticate the user. Transaction account network 110 may determine whether the user exists (Block 304). If the user does exist, transaction account network 110 may provision the existing user for use on the current device (Block 306). If the user does not exist, transaction account network 110 may proceed with user registration by determining whether the user is likely a real person (Block 308). Factors such as geolocation, social media data, and existing transaction account data may be compared to determine whether the proposed user registration corresponds to a real user.

In various embodiments, transaction account network 110 may create a PIN using user input (Block 310). Although PIN is given as an exemplary authentication method, other authentication methods may also be registered such as biometrics, passwords, OTP, and/or other authentication techniques. Transaction account network may determine if the authentication (e.g., PIN) creation was suspicious (Block 312). PIN creation, for example, may be suspicious if the PIN creation and submission process was completed at an impossibly fast rate for a human being. Facial recognition creation may be suspicious if the picture submitted is too similar to a known existing picture (e.g., with the same clothes, angle, and background as a known profile image).

In various embodiments, transaction account network 110 may suggest alternative registration to the user in response to a suspicious PIN (or other authentication key) creation (Block 314). Transaction account network 110 may retrieve a geographic location of the user in response to a non-suspicious PIN creation (Block 316). The geographic location, or geo location, may be retrieved from the GPS location system of customer device 102 or merchant device 104 that the user is using. The location may also be derived by the IP address that customer device 102 and/or merchant device 104 is using to communicate with transaction account network 110. Transaction account network 110 may use the location to determine whether the location is appropriate for the user (Block 318). For example, if a transaction account has only made transactions in the United States over the past 10 years, then it is unlikely that a user attempting registration from a location in China is authentic.

In response to an inappropriate user location, transaction account network 110 may suggest an alternative registration technique such as in-person or over-the-phone registration (Block 314). In response to detecting an appropriate user location, transaction account network 110 may retrieve user information (Block 320). Transaction account network 110 may use the user information to determine whether the user information matches internal records (Block 322). Transaction account network 110 may suggest alternate registration in response to the information not matching (Block 314). Transaction account network may create the user ID and/or issue a user certificate in response to matching information (Block 324). The user is now provisioned and may transact on provisioned devices. The user certificates and device certificates may be used for encryption to provide secure communication during the transaction process.

With reference to FIG. 4, a process 400 for completing secure transactions on system 100 is shown, in accordance with various embodiments. The communication in process 400 between customer device 102 and merchant device 104 may be conducted across communication channel 106 (e.g., a BLE connection). Communication to and from transaction account network 110 may be conducted across network 108 (e.g., the Internet).

In various embodiments, customer device 102 may let the merchant device 104 know that the customer device is ready to begin a transaction using communication channel 106 (Block 402). Merchant device 104 may open the transaction with transaction account network 110 by making the device visible on communication channel 106. For example, merchant device 104 may turn on BLE and as soon as the BLE-enabled customer device 102 may detect merchant device 104 as a BLE server. In conjunction with the BLE connection of communication channel 106 being allowed in by the merchant device 104, the merchant device may transmit merchant data to transaction account network 110 over network 108 (Block 404). The transmission from merchant device 104 to transaction account network 110 may include a merchant session key (e.g., an SPI key or other time-based token), merchant ID, payment amount, and the certificate for merchant device 104. The certificate for merchant device 104 may include device specific information such as a UUID, MAC address, and other unique characteristics that are only to be found on merchant device 104. The communication to transaction account network may be completely or partially encrypted using the device certification and the user certification assigned to the merchant device 104 and the user of merchant device 104.

In response to the merchant transmission of block 404, transaction account network 110 may transmit back a transaction account network session key (e.g., an SPI key or other time-based token) and indicia that the transmission was successful (e.g., an HTTP 200 response) (Block 406). Merchant device 104 may transmit merchant information to customer device 102 across communication channel 106 (Block 408). The merchant information sent to customer device 102 may include the merchant session key (e.g., the SPI key or other time-based token) as well as a transaction amount.

In various embodiments, customer device 102 may transmit merchant data for verification and customer data to transaction account network 110 (Block 410). Transaction account network may verify the merchant session key received from customer device 102 by comparing it to the merchant session key received from merchant device 104. In addition to the merchant session key, customer device 102 may transmit the customer session key (e.g., an SPI key or other time-based token), customer ID, transaction amount, and the certificate for customer device 102. The certificate for customer device 102 may include device specific information such as UUID, MAC address, and other characteristics of customer device 102. The transmissions from customer device 102 to transaction account network 110 may be encrypted. The encryption may be enciphered using, for example, the user certificate and device certificate for the user of customer device 102 and customer device 102, respectively. The user certificate may include, for example, the PIN previously generated during provisioning.

In various embodiments, in response to verifying the customer session key, the customer ID, and/or the merchant session key, transaction account network 110 may check the transaction amount to verify that the transaction amount sent by merchant device 104 matches the amount sent by customer device 102. In response to verification of the aforementioned information, transaction account network 110 may transmit to customer device 102 the same transaction account network session key that was sent to merchant device 104 (Block 412). The customer may transmit the same transaction account network session key to merchant device 104 to verify that the transaction was successful (Block 416).

In various embodiments, merchant device 104 may transmit to customer device 102 that the transaction account network session key received from customer device 102 matches the transaction account network session key received by merchant device 104 from transaction account network 110 (Block 416). Customer device 102 may transmit validation credentials to transaction account network (Block 418). Merchant device 104 may also transmit validation credentials to transaction account network (Block 420). Validation credentials may include the merchant session key, customer session key, and amount. Transaction account network 110 may verify that none of the information has been modified prior to approving the transaction. Transaction account network may also send a response to merchant device 104 and customer device 102 to indicate the transaction is complete and has succeeded or failed.

Transactions conducted using the foregoing systems and methods tend to ensure transaction security. The communication between customer device 102 and merchant device 104 across a short-distance communication channel, such as BLE, reduces the availability of the transmissions to eaves droppers and limits the possibility of spoofing devices. The exchange of three unique identifiers between three parties as disclosed above enhances detection of manipulated identifiers and/or transaction amounts.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® NT®, 95/98/2000/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®), a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.45.67.89). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account network” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “customer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Transaction account network may include a payment processor, a gateway, or the like. Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who completes the payment transaction. In response to the verification being denied, the payment processor relays the information to the merchant, who may decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a transaction account network, a merchant identifier, a first merchant session key, a merchant device certificate, and a first transaction amount from a merchant device;
transmitting, by the transaction account network, a time-based token to the merchant device;
receiving, by the transaction account network, a second merchant session key, a customer session key, a customer ID, a customer device certificate, and a second transaction amount from a customer device;
matching, by the transaction account network, the first merchant session key to the second merchant session key; and
transmitting, by the transaction account network, the time-based token to the customer device in response to the first merchant session key matching the second merchant session key.

2. The method of claim 1, further comprising:
matching, by the transaction account network, the first transaction amount to the second transaction amount; and
transmitting, by the transaction account network, the time-based token to the customer device in response to the first transaction amount matching the second transaction amount.

3. The method of claim 1, wherein the second merchant session key is received by the customer device from the merchant device over a short-range communication channel.

4. The method of claim 3, wherein the short-range communication channel comprises a Bluetooth Low Energy (BLE) link.

5. The method of claim 3, further comprising:
provisioning, by the transaction account network, the customer device with the customer device certificate; and
provisioning, by the transaction account network, the merchant device with the merchant device certificate.

6. The method of claim 1, further comprising receiving, by the transaction account network, a first validation credential from the customer device and a second validation credential from the merchant device.

7. The method of claim 6, further comprising comparing, by the transaction account network, the first validation credential to the second validation credential to detect an alteration.

8. A computer-based system, comprising:
a processor;
a tangible, non-transitory memory configured to communicate with the processor, the tangible, non-transitory memory having instructions stored thereon that, in response to execution by the processor, cause a transaction account network to perform operations comprising:
receiving, by the transaction account network, a merchant identifier, a first merchant session key, a merchant device certificate, and a first transaction amount from a merchant device;
transmitting, by the transaction account network, a time-based token to the merchant device;
receiving, by the transaction account network, a second merchant session key, a customer session key, a customer ID, a customer device certificate, and a second transaction amount from a customer device;
matching, by the transaction account network, the first merchant session key to the second merchant session key; and
transmitting, by the transaction account network, the time-based token to the customer device in response to the first merchant session key matching the second merchant session key.

9. The computer-based system of claim 8, further comprising:
matching, by the transaction account network, the first transaction amount to the second transaction amount; and
transmitting, by the transaction account network, the time-based token to the customer device in response to the first transaction amount matching the second transaction amount.

10. The computer-based system of claim 8, wherein the second merchant session key is received by the customer device from the merchant device over a short-range communication channel.

11. The computer-based system of claim 10, wherein the short-range communication channel comprises a Bluetooth Low Energy (BLE) link.

12. The computer-based system of claim 8, further comprising:
provisioning, by the transaction account network, the customer device with the customer device certificate; and
provisioning, by the transaction account network, the merchant device with the merchant device certificate.

13. The computer-based system of claim 8, further comprising receiving, by the transaction account network, a first validation credential from the customer device and a second validation credential from the merchant device.

14. The computer-based system of claim 13, further comprising comparing, by the transaction account network, the first validation credential to the second validation credential to detect an alteration.

15. An article of manufacture including a non-transitory, tangible computer readable storage medium having instructions stored thereon that, in response to execution by a computer-based system, cause a transaction account network to perform operations comprising:
receiving, by the transaction account network, a merchant identifier, a first merchant session key, a merchant device certificate, and a first transaction amount from a merchant device;
transmitting, by the transaction account network, a time-based token to the merchant device;
receiving, by the transaction account network, a second merchant session key, a customer session key, a customer ID, a customer device certificate, and a second transaction amount from a customer device;
matching, by the transaction account network, the first merchant session key to the second merchant session key; and
transmitting, by the transaction account network, the time-based token to the customer device in response to the first merchant session key matching the second merchant session key.

16. The article of claim 15, further comprising:
matching, by the transaction account network, the first transaction amount to the second transaction amount; and
transmitting, by the transaction account network, the time-based token to the customer device in response to the first transaction amount matching the second transaction amount.

17. The article of claim 15, wherein the second merchant session key is received by the customer device from the merchant device over a short-range communication channel.

18. The article of claim 15, further comprising:
provisioning, by the transaction account network, the customer device with the customer device certificate; and
provisioning, by the transaction account network, the merchant device with the merchant device certificate.

19. The article of claim 15, further comprising receiving, by the transaction account network, a first validation credential from the customer device and a second validation credential from the merchant device.

20. The article of claim 19, further comprising comparing, by the transaction account network, the first validation credential to the second validation credential to detect an alteration.
